(19) United States
(12) Patent Application Publication
(10) Pub. No.: US 2014/0049439 A1
(43) Pub. Date: Feb. 20, 2014

(54) COMPACT DUAL-POLARIZED MULTIPLE DIRECTLY FED & EM COUPLED STEPPED PROBE ELEMENT FOR ULTRA WIDEBAND PERFORMANCE

(71) Applicant: Jimmy HO, Hickory, NC (US)

(72) Inventor: Jimmy HO, Hickory, NC (US)

(21) Appl. No.: 13/588,730

(22) Filed: Aug. 17, 2012

(51) Int. Cl. H01Q 1/50

(52) U.S. Cl. 343/852; 343/858

(57) ABSTRACT

A compact antenna element and assembly using a directly fed and electromagnetically coupled step probe element for ultra wideband application. It achieves very good impedance match, isolation and pattern stability across a wide frequency band. The compact ultra wideband radiating element covers all known radio frequency bands in the mobile base station industry to date.

### BACKGROUND OF THE INVENTION

1. Field of the Invention

The present invention relates to a compact dual-polarized antenna element with very good Voltage Standing Wave Ratio (VSWR), isolation and pattern stability across a very wide frequency band. It achieves this via directly feeding and electromagnetically coupling stubs of different lengths similar to a multi-section transformer, in the feed. In the invention, this multiple directly fed and electromagnetically coupled stubs in the feed are shortened to multi-DF&EMC (directly fed & electromagnetically coupled) stepped probe.

2. Background of the Related Art

The mobile base station industry is becoming increasingly more competitive. As new frequency bands are being made available, it is a goal of those involved in the design and use of mobile base station antennas and other related systems to maintain or reduce costs, while maintaining or improving upon electrical performance across a broader range of frequency bands.

United Kingdom Pat. No. GB 2405997B, the entirety of which is incorporated herein by reference, describes a multi-band element designed for multi-band base station antenna arrays operating from 806 MHz to 960 MHz (often referred to as the low band) and 1710 MHz to 2170 MHz (often referred to as the high band). Although it has superior impedance matching performance (VSWR 1.3:1), it exhibits inferior intra-port isolation and cross-polarization, when applied to work in a dual polarized configuration because the elements are fed on or near the edge of the patch.

Accordingly, there exists a need for a compact dual polarized radiating element with ultra-wideband performance that exhibits good VSWR, good isolation, and a good azimuth pattern across a wide band of operating frequencies whilst still being of inexpensive construction. This invention improves the impedance bandwidth but applied in a balanced configuration to correct for the poor isolation and pattern stability. The multiple directly fed steps to improve the bandwidth is further enhanced significantly by employing additional EM coupling steps to expand the bandwidth and improve the matching performance further.

### SUMMARY OF THE INVENTION

It is an object of the invention to provide an improved multiple step probe approach with significantly improved impedance bandwidth and match through additional electromagnetically coupled (EMC) steps by using printed circuit boards (PCB's) and then balancing the probe through two different techniques to fix the isolation and pattern response across this ultra-wide frequency bandwidth. It is another object of the invention to provide a multi-band element which includes a low band element configured to operate over a frequency band of 695 MHz-960 MHz, and a high band element configured to operate over a frequency band of 1700 MHz-2700 MHz.

Those and other objects are achieved by an antenna assembly having: a ground plane; a multi-DF&EMC step probes for wide impedance bandwidth enhancements and having a first coupling patch suspended above the ground plane.

Each multi-DF&EMC step probe may comprise of several vertical and horizontal conductors etched on a microwave quality PTFE substrate. Although a lossy substrate like FR4 (which is a standard PCB material or fiberglass reinforced epoxy laminates that are flame retardant) could be used for the multi-DF&EMC step probe, the design will further implement a distribution feed network on the same substrate and to minimize the insertion loss, a quality PTFE substrate is used. In fact, any conductor, including airline could be used. The multi-DF&EMC step probe may be configured such that the elements form a pair in which each element is fed a signal 180° out of phase.

With those and other objects, advantages, and features of the invention that may be hereinafter apparent, the nature of the invention may be more clearly understood by reference to the following detailed description of the invention, the appended claims, and to the several drawings attached herein.

### BRIEF DESCRIPTION OF THE DRAWINGS

FIG. 1 is a perspective view of an antenna assembly in accordance with an exemplary embodiment of the invention;

FIG. 2 is a perspective view of a vertically polarized assembly of the multiple directly fed step probe;

FIG. 3 is a detailed view of the multiple directly fed step probe element in accordance with an exemplary embodiment of the invention;

FIG. 4 is a detailed view of the multiple fed step probe element that is fed via electromagnetic coupling in accordance with an exemplary embodiment of the invention;

FIG. 5 is a detailed view of the multiple directly fed and electromagnetically coupled (multi-DF&EMC) step probes in accordance with an exemplary embodiment of the invention;

FIG. 6 is a perspective view of a vertically polarized assembly showing both the front view (FIG. 6(a)) and the back view (FIG. 6(b)) of the multi-DF&EMC step probe with radiating element and ground plane;

FIG. 7 is a perspective view of a dual polarized assembly showing the multi-DF&EMC step feed with radiating element and ground plane;

FIG. 8 is a detailed view of the multi-DF&EMC step probes arranged in a balanced configuration for one polarization;

FIG. 9 is a detailed view of the multi-DF&EMC step probes arrange in a balanced configuration for the other polarization;

FIG. 10 is a detailed perspective view of the balanced multi-DF&EMC step probe with radiating element and ground plane; and

FIG. 11 is a perspective view of a pair of elements arranged such that it behaves similar to layout of FIG. 10.

### DETAILED DESCRIPTION OF THE PREFERRED EMBODIMENTS

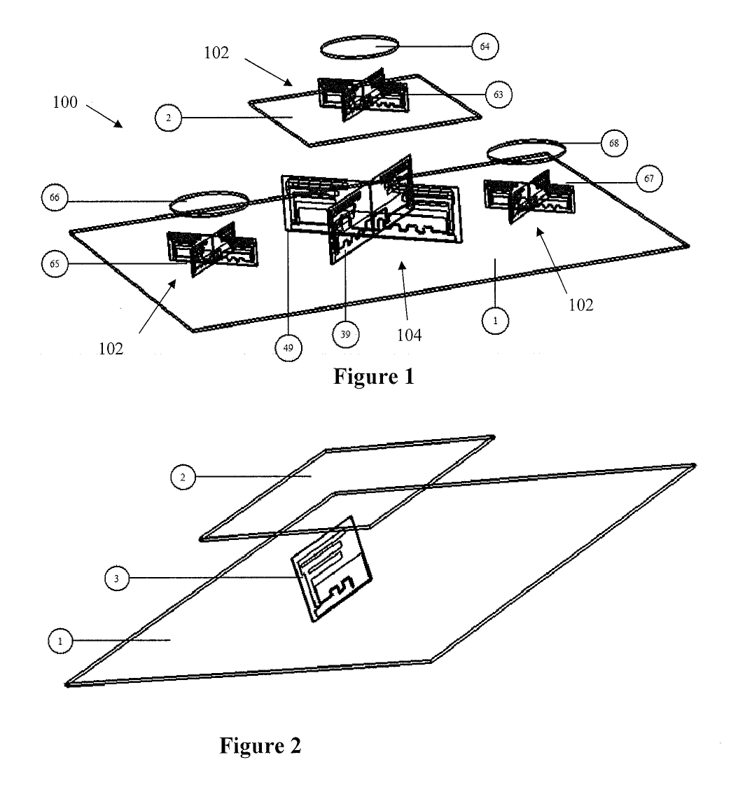

With reference to FIG. 1, an antenna assembly 100 is shown in accordance with an exemplary embodiment of the present invention. The antenna assembly 100 includes a number of high band radiator assemblies 102, a low band radiator assembly 104, and, a ground plane 1 (a conductor, generally aluminum). Each of the high band radiator assemblies 102 are formed of high band elements 63, 65, 67 and a respective high band top plate 64, 66, 68. The low band radiator assembly 104 is formed of low band elements 39, 49 and a low band top plate 2. The top plates 2, 64, 66, 68 are aligned with and suspended over the respective radiator elements 39/49, 63, 65, 67. As illustrated, the high band assemblies 102 are about one-half the size of the low band assembly 104.

The high band elements 63, 65, 67 and the low band elements 39/49 each include two elongated flat conductive sheets that are coupled together in the form of an X-shape (slant +/−45, dual polarized). The elements 39/49, 63, 65, 67 stand upright on their edges, with the top and bottom surfaces facing substantially orthogonal to the ground plate 1. A plate 2, 64, 66, 68 is placed over each of the elements 39/49, 63, 65, 67, respectively. The high band plates 64, 66, 68 are generally circular in shape, and the low band plate 2 is rectangular in shape, though any suitable shape can be utilized. An air gap or non-conductive medium (such as plastic or insulator) is positioned between the plates 2, 64, 66, 68 and the elements 39/49, 63, 65, 67. The plates 2, 64, 66, 68 are electromagnetically coupled with the respective elements 39/49, 63, 65, 67, and radiate energy. The plates 2, 64, 66, 68 can be larger (though need not be, and can be smaller) than those elements 39/49, 63, 65, 67.

Additionally, the high band elements (1700-2700 MHz) 63, 64 can be stacked on top of the low band element (695-960 MHz) 39/49, 2 to form a dual-band dual-polarized assembly and those assemblies can be interleaved with one another to form a compact antenna array. The band elements 63, 64 directly contact the low band plate 2 and use the low band plate 2 as a ground. The high band elements 65, 66 and 67, 68 are placed inline with the low band element 39/49, 2 and can share the same ground plane or are suspended above the ground plane on insulators. Thus, the two high band elements 65, 67 are placed on the ground plane 1, with the low band assembly 39/49 between them aligned linearly.

Thus, FIG. 1 illustrates how the radiating elements using multi-DF&EMC probes can be configured for multi-band operation. The high band radiators 63 using the multi-DF&EMC probes can be stacked above the low band radiator 39/49 and also interleaved between the low band radiators 39/49. In the drawing, the high band multi-DF&EMC probes 63, 65, 67 are arranged such that the probes face each other but fed 180° out of phase. The high band radiators 64, 66, 68 are excited by the multi-DF&EMC probes 63, 65, 67.

The antenna assembly may further comprise metal radiators disposed above the low band elements, high band elements disposed on the low band radiator, and a high band element disposed between the low band elements. A plurality of such antenna assemblies may be provided in an array.

In the following few descriptions, the preferred embodiment of the invention will concentrate on the 695-960 MHz design. This achieves a bandwidth of 32% with a VSWR of 1.35:1. The design can be extended to 1700-2700 MHz. This achieves a bandwidth of 45% with a VSWR of 1.35:1. The feed method described achieves beyond the operating frequency of those 2 bands. However, the bands are limited to operate from 695-960 MHz and 1700-2700 MHz as these are the operating bands for today's current mobile communications systems. However, the invention can be applied to other suitable designs and applications outside of these ranges.

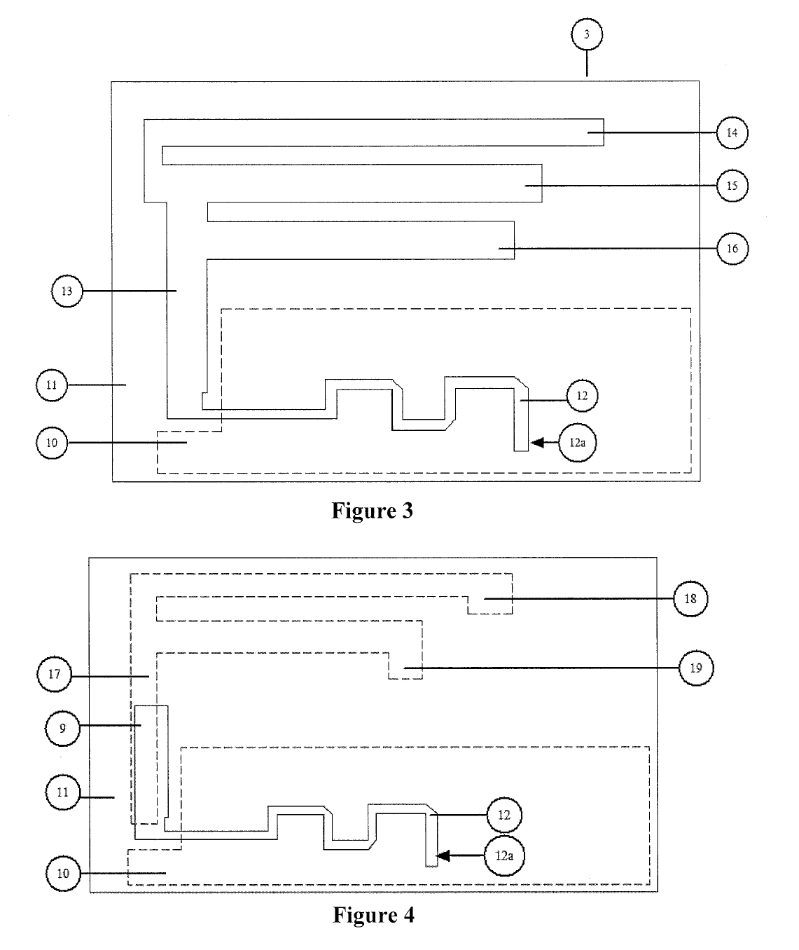

FIG. 2 shows wide band impedance performance can be achieved by having a multi-step feed element 3 on a PCB with multiple horizontal/vertical probes or conductors 13-16 (FIG. 3). The multi-step feed element 3 of FIG. 2, is on a PCB connected to a metal ground plane 1 and coupled with a primary suspended metal radiator 2.

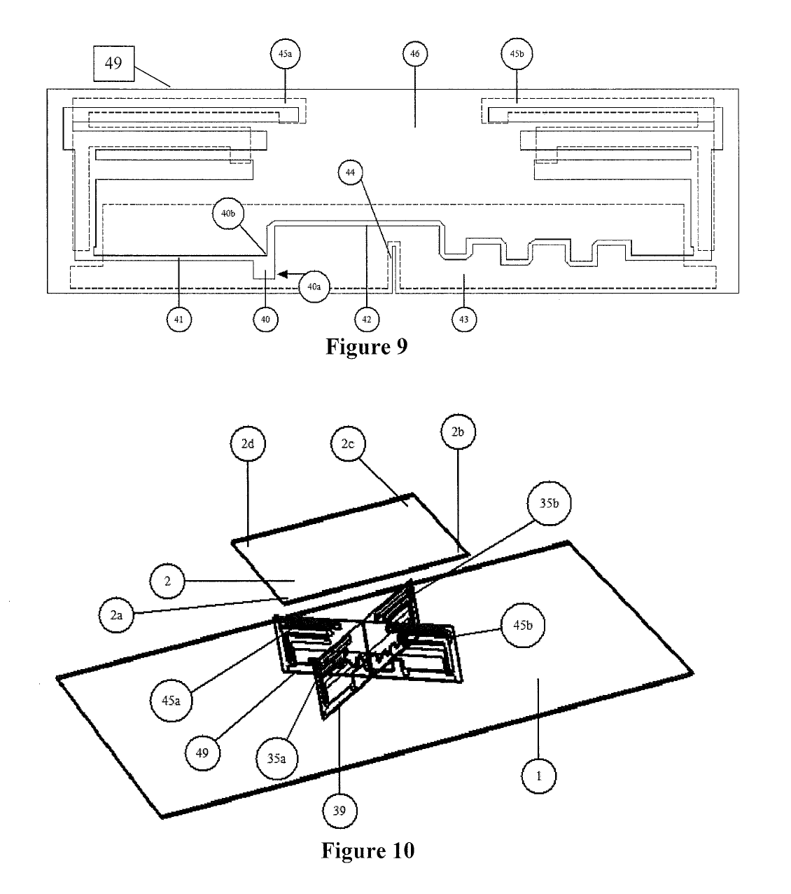

FIG. 3 is a more detailed illustration of the multi-step feed element 3 from FIG. 2. The horizontal conductors 14, 15, 16 are parallel to one another and extend substantially parallel with respect to the top edge of the PCB and the ground plane 1. The vertical conductor 13 extends substantially orthogonal to the top edge of the PCB and the ground plane 1, and orthogonal to the horizontal conductors 14, 15, 16. The feed network 12 is etched on a PCB 11 residing above a ground plane 10. The solid lines represent the front surface of the PCB 11 and the dashed lines illustrate the back surface of the PCB 11. The feed network 12 is excited at point 12a via a coaxial cable. The inductance of the vertical conductor 13 (or probe) is compensated (i.e., cancelled) by the capacitances of the multiple horizontal conductors 14, 15, 16 (or probes). The vertical and horizontal conductors (probes) cancel; so if the height of the vertical conductor 13 is increased, the length of the horizontal conductors 14, 15, 16 needs to be increased, which can be limited by a particular application so that the horizontal conductors don't run into each other (e.g., see FIGS. 8, 9).

The configuration of the feed element 3 shown in FIG. 3 achieves a reasonably good performance across a 32% bandwidth from 695-960 MHz and 45% bandwidth from 1700-2700 MHz. However, additional steps (i.e., the horizontal conductors) allow for a larger bandwidth and more freedom of tuning for improved VSWR because of more components to aide in compensation purposes. Unfortunately, it is not possible to increase the number of steps because of two reasons. Firstly, the horizontal conductor 16 must not touch or overlap the ground plane 10 otherwise there will be a severe mismatch as the fields will not be between the conductor 16 and air but predominantly between the conductor 16 and the ground plane 10. The horizontal conductor 16 is generally kept approximately 5 mm above the PCB ground plane 10. These are etched on a PCB so therefore can easily be separated. Secondly, the primary radiator 2 is placed approximately 0.12λ above the ground plane 1 in the current configuration for good matching purposes. That is, the VSWR is minimized. To transfer energy from the feed to the radiator, the impedance between these two components must be matched to have a similar impedance. Hence, the vertical conductor 13 and the horizontal conductors 14, 15, 16 have only a small window to operate. The horizontal conductors 14, 15, 16 vary from 0.05λ-0.13λ and the vertical conductor 13 varies from 0.03λ to 0.1λ, although values outside this range will also work.

FIG. 4 shows another configuration for the feed element 3 that can be utilized in conjunction with FIG. 3. Shown therein is the multiple steps probe with vertical conductor 17 and horizontal conductors 18, 19. The conductors 17, 18, 19 together form one single conductor. Since the conductors 17, 18, 19 are on the back surface of the PCB and the microstrip section 9 is on the front surface of the PCB, the conductors 17, 18, 19 are electromagnetically coupled with the microstrip section 9, which is fed from the microstrip feed 12. These components 17, 18, 19 are fed from a microstrip feed 12 and energy is delivered via electromagnetic coupling via a large microstrip section 9. As shown, the vertical conductor 17 on the rear surface of the board is aligned with and overlaps the microstrip section 9 on the front surface of the board, to ensure a strong electromagnetic coupling between those elements. It is noted that any suitable number of conductors can be utilized, though FIG. 4 shows 2 horizontal conductors and FIG. 3 illustrates 3 horizontal conductors. The microstrip section 9 couples energy from the feed 12 to the conductors 17, 18, 19. The conductor 9 needs to be a certain size and shape to provide a good transition between the feed 12 and the conductors 17, 18, 19. That size and shape is optimized on the 3D EM simulator CST Microwave Studio.

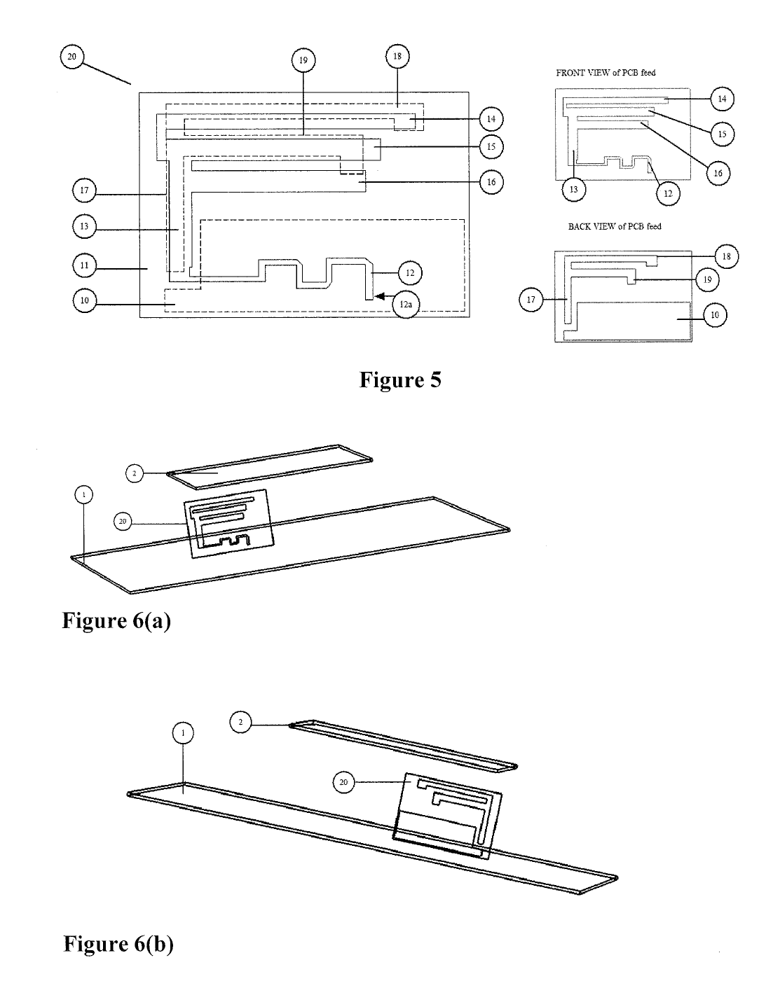

Thus, FIGS. 3 and 4 essentially do the same thing, except that FIG. 4 is EM coupled and FIG. 3 is directly fed. FIGS. 3 and 4 are combined to provide the configuration shown in FIG. 5, with FIG. 3 (shown in solid lines) provided on the front of the PCB and FIG. 4 (shown in dashed lines) provided on the back of the PCB. FIG. 5 provides a larger bandwidth and more freedom to tune because instead of one set of steps (i.e. FIG. 3 or FIG. 4) to match the probe to the radiator, you have additional steps (probes) which could be tuned to work across a slightly higher or lower frequency and more options to tune for improved VSWR because there are more steps/stubs to adjust.

Shown in FIG. 5 is the multiple directly fed (DF) steps probe (i.e., FIG. 3) but with additional electromagnetically coupled (EMC) vertical conductor 17 and multiple horizontal conductors 18, 19 (from FIG. 4) placed on the back of the PCB (as represented by the dashed lines). The additional EMC vertical and horizontal conductors 17, 18, 19 provide improved impedance matching (i.e., better VSWR across the band) and increase the bandwidth as additional lengths are employed. The vertical and horizontal conductors 17, 18, 19 on the back of the PCB need not be (though can be) aligned with the conductors 13, 14, 15, 16 on the front of the PCB. Any arbitrary shaped can be used. Preferably, however, the vertical conductor 17 on the rear surface of the board is aligned with and overlaps with the vertical conductor 13 on the front surface of the board to ensure a strong electromagnetic coupling between those elements. The PCB used in this design is 0.8mm thick, though any suitable thickness can be used.

FIG. 6(a) shows the front view and FIG. 6(b) shows the back view of the antenna element assembly with the ground plane 1, the primary radiator 2, and the multiple direct fed and electromagnetically coupled (multi-DF&EMC) step probe 20, for single polarization. The step probe 20 corresponds to the probe element of FIG. 5, but the probe elements 3 of FIGS. 3 and 4 can also be utilized.

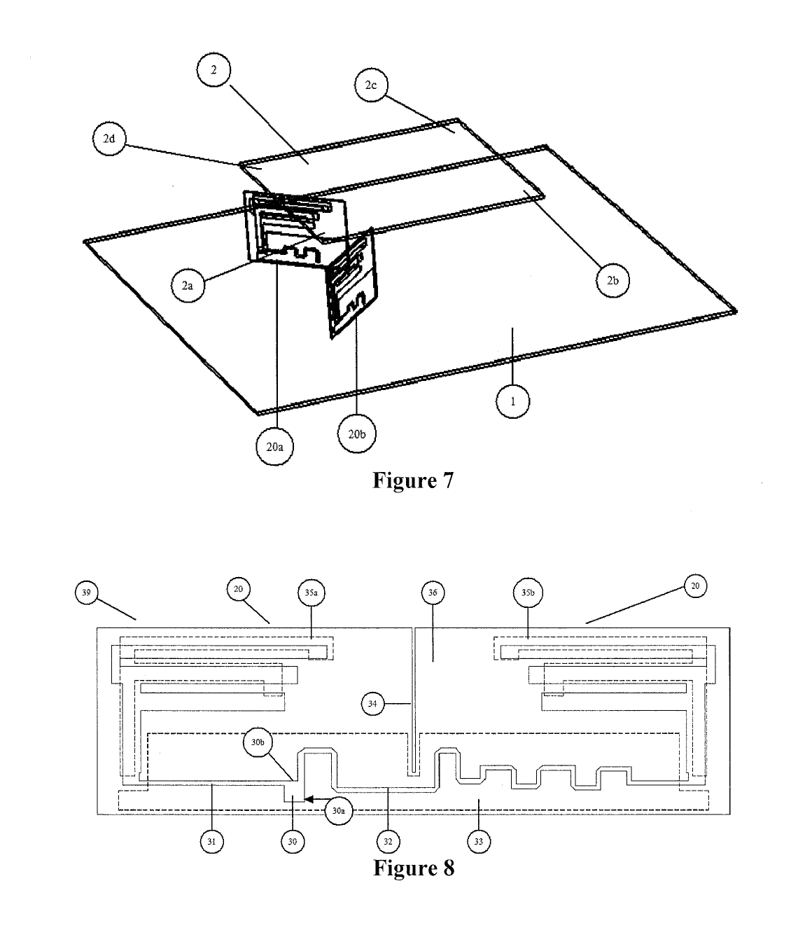

FIG. 7 provides a view on the setup for a dual-polarized application. In this design, the multi-DF&EMC step probes 20a, 20b are arranged such that the probes 20a, 20b are arranged in a ±45° configuration. The probes 20a, 20b are in contact with a ground plane 1 and are coupled with a low band top plate 2. The probes 20a, 20b are each the same as the probe element 20 shown in FIGS. 5 and 6a, 6b. In FIG. 6, the design is vertically polarized and the feeds are arranged in a slant +/−45 degree configuration for dual polarization. As with the single vertically polarized configurations of FIG. 4, the VSWR on the slant 45 dual polarized configuration is very good owing to the broad band design of the multi-DF&EMC step probe. However, because the primary radiator (or patch) 2 is excited on the edge, the isolation between 20a, 20b is very poor. This is typically on the order of −12 dB. Apart from the poor isolation, the pattern is less stable and often squint over a large frequency band.

FIG. 8 show a balanced configuration 39 whereby the multi-DF&EMC step probes 35a, 35b are fed 180° out of phase. Here, the probe 20 of FIG. 5 is mirrored with itself and joined together to form a single one-piece elongated probe 39 having two nearly identical halves 20. The vertical conductors 17, 13 are positioned toward the outside portions of the board 38 so that they are further away from each other, and the horizontal conductors 14, 15, 16, 18, 19 extend inward toward the center of the board 38. However, the vertical conductors 13, 17 can be positioned toward the center of the PCB at the inside of the respective probes 20, with the horizontal conductors extending outward. The only difference between the probe halves 20 is that the length of the conductive track 32 (on the left probe half in the embodiment shown) is 180° of phase longer than the length of the conductive track 31 (on the right probe half in the embodiment shown). This is done because the radiator is approximately half a wavelength, the opposite ends 2a, 2c (FIG. 7) needs to be fed 180 degrees out of phase otherwise the electric fields cancel.

The configuration of the probe 39 offers high performance. The probe 39 is balanced electrically because the radiator 2 is fed at both ends 2a, 2c as oppose to transferring energy from the probes to the radiator at one end 2a only. With this configuration, the VSWR is still very good across a wide frequency band but the isolation has improved markedly to better than −30 dB from −12 dB and the radiation pattern is very stable a very wide frequency band. The feed network 30 is excited at point 30a and resides above a ground plane 33 on the PCB 36. Power from an input port 30a is then split equally (preferable but not always the case) at junction 30b. The power is then carried to multi-DF&EMC step probes 35a and 35b via conductive tracks 31 and 32 respectively.

FIG. 9 shows a balanced configuration for a probe 49 whereby the multi-DF&EMC step probes 45a, 45b are fed 180° out of phase. The feed network 40 is excited at point 40a and resides above a ground plane 43. Power from input port 40 is then split equally (preferable but not always the case) at junction 40b. The power is then carried to multi-DF&EMC step feeds 45a and 45b via conductive tracks 41 and 42 respectively. The length of the conductive track 42 is 180° longer than the length of conductive track 41.

The probe 49 is nearly identical to the probe 39 of FIG. 8, except as to the slots 34, 44. As shown in FIG. 8, the PCB 38 has a slot 34 extending vertically downward from the top of the PCB 38 at the middle of the probe 39 to divide the probe 39 in half. The slot 34 extends nearly to the bottom of the PCB 38. And as shown in FIG. 9, the PCB 46 has a slot 44 that extends vertically upward from the bottom of the PCB 46 at the middle of the probe 49 to divide the probe 49 in half. The slot 44 extends only slightly upward by a distance that is about the same (or slightly greater than) as the distance from the slot 34 to the bottom of the PCB 36 in FIG. 8. Accordingly, the slots 34, 44 from FIGS. 8 and 9 respectively mate together so that the probes 39, 49 to form an X-shaped cross. The slot 44 slides down through slot 34 so that the probes 39, 49 engage one another in a friction fit.

FIG. 10 shows the balanced configuration whereby the balanced multi-DF&EMC step probes are mirrored and fed 180° out of phase with each other, for dual polarization. By feeding the radiator 2 on the edge, the currents across the radiator 2 will be different at the opposite ends 2b, 2d of the radiator 2 along the diagonal. The result is poor cross polar discrimination and poor pattern stability. This improves by mirroring the probes 20a, b and feeding the probes 180 degrees out of phase.

FIG. 10 show the dual polarized balanced multi-DF&EMC step feeds arranged in a ±45° configuration. A coupling radiator patch (i.e., low band top plate) 2 is a flat sheet of metal that resides above the mated configurations 39, 49. Here, the coupling patch 2 is approximately 0.12× above the ground plane 1. The coupling patch 2 may have any other arbitrary shape that is appropriate for the application for which it is desired. This shape could have bent up walls or shaped like a box. Alternatively, additional radiating patches can be stacked for further bandwidth enhancements although it is not required in this design as it already meets the operating frequency bandwidth without the additional coupling patches. FIG. 10 resolves the drawback of FIG. 7 where the isolation and pattern stability becomes an issue over a wide frequency band. That is, the multi-DF&EMC probes are now exciting both ends 2a, 2c and 2b, 2d of the radiator 2. It is also fed 180° out of phase because the radiator is approximately ½ a wavelength long. The currents are therefore more balanced than in FIG. 7, where it is only excited at one end (end 2a for one polarization and end 2d for the other) of the radiator. Because of this configuration, patterns show better stability and isolation whilst still maintaining the wide impedance matching characteristics of the multi-DF&EMC probes.

Referring to FIGS. 1 and 10, high band assemblies 102 are added to the configuration of FIG. 10 to provide FIG. 1. A high band assembly 102 is added to opposite sides of the low band assembly 104 on the ground plane 1, with the low band assembly 104 therebetween. In addition, a high band assembly 102 is stacked on top of the low band assembly 104, as mentioned above. The high band elements 102 are typically close to twice the frequency of operation as the low band elements. This turns the dual polarized element of FIG. 10 to a multi-band dual polarized configuration of FIG. 1 operating from 695-960 MHz and 1700-2700 MHz.

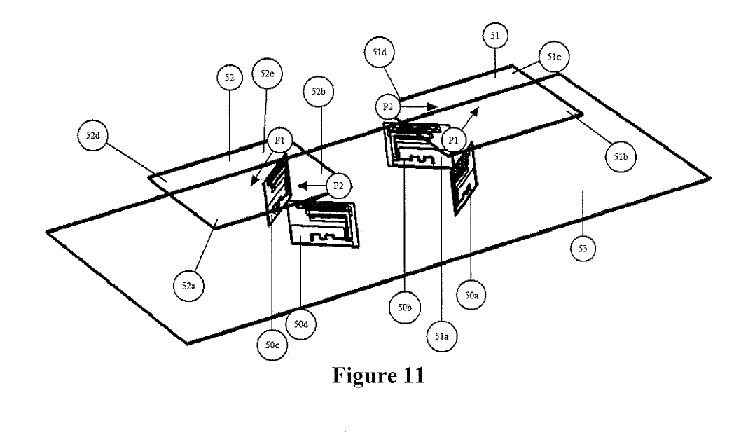

Referring to FIG. 11, alternatively from a further cost reduction point of view, the structure of FIG. 7 can be made to emulate FIG. 10 by employing two radiating assemblies and then feeding them 180° out of phase. Here, the radiating elements 50a, 50b and their respective top plate 51 make up one radiating assembly and radiating elements 50c, 50d and top plate 52 make up another radiating assembly. The top plates 51, 52 have respective ends or corners 51a-d, 52a-d. The radiating elements 50a, 50b, 50c, 50d can either be high band or low band, as with FIG. 10. The surfaces of the PCBs of the radiating elements 50a, 50b, 50c, 50d are generally facing inward toward one another. The radiating elements 50a, 50b form a first pair and are separated from each other; and the radiating elements 50c, 50d form a second pair are also separated from each other. Thus, the radiating elements 50a, 50b, 50c, 50c generally form the sides of a square or rectangular shape but are open on the corners so that they are not directly connected with each other. In addition, the vertical conductors of each pair are at the side of the radiating elements 50a, b, c, d that are furthest away from each other. Thus, for instance, the vertical conductor of element 50c is at the far side of the element 50c with respect to element 50d in that pair; likewise, the vertical conductor of element 50d is at the far side of that element 50d with respect to element 50c.

Although it is still being fed at one end or corner 51a, 52c, and 51d, 52b of the radiating patch, the combination behaves like a single balanced element of FIG. 10. In the mobile station industry, sidelobe suppression can still be maintained by employing pairs of elements fixed in an array. With reference to FIG. 11, if multi-DF&EMC step feeds 50a is fed 180° out of phase with multi-DF&EMC step feed 50c, the end result is an element with higher gain as there are now two elements in the array but it's behavior is very similar to that of the balanced feed structure of FIG. 10 but using only half the PCB substrate.

Similarly, if multi-DF&EMC step feeds 50b is fed 180° out of phase with multi-DF&EMC step feed 50d, the end result is an element with higher gain as there are now two elements in the array but it's behavior is very similar to that of the balanced feed structure of FIG. 10 but using only half the PCB substrate. Note that multi-DF&EMC step feeds 50a and 50c have the same polarization, designated as P1. Multi-DF&EMC step feeds 50b and 50d have the same polarization, designated as P2. The multi-DF&EMC step feds can be fed via coaxial cable, PCB's or airline. The low band radiators 51, 52 are conductors usually made of aluminum but a PCB with a metal ground plane etched on it will provide the same function. The ground plane 53 is also a conductor, typically aluminum although any conductor will do. An airline is a metal conductor that is suspended in air a short distance above the ground plane. Because air is the medium, the insertion of the network using airline is very low.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An antenna assembly comprising:
a ground plane; and
an assembly having a coupling patch radiator suspended above the ground plane, and multiple directly fed step probe elements disposed between the ground plane and the coupling patch radiator.

2. The antenna assembly of claim 1,

3. The antenna assembly of claim 1, said multiple directly fed step probe elements comprising a plurality of horizontal conductors.

4. The antenna assembly of claim 2, said multiple directly fed step probe elements further comprising a vertical conductor.

5. The antenna assembly of claim 1, wherein each multiple directly fed step probe element is electromagnetically coupled to a further multiple step fed element for improved matching and bandwidth extension.

6. The antenna assembly of claim 2, wherein the multi-DF&EMC step probes are arranged in a ±45° configuration for dual polarization application.

7. The antenna assembly of claim 1, wherein the multi-DF&EMC step probes are arranged in a ±45° configuration for dual polarization application.

8. The antenna assembly of claim 4, wherein multi-DF&EMC step probes are arranged in a balanced configuration and fed 180° out of phase to improve on the pattern stability and isolation significantly.

9. The antenna assembly of claim 5, further comprising a high band element disposed above a low band element forming a dual-band dual-polarized element.

10. The antenna assembly of claim 4, wherein the multi-DF&EMC step probes are fed on the edges of the two radiating elements and fed 180° out of phase to achieve higher gain and also achieve good isolation and pattern stability using less material.

11. The antenna assembly of claim 7, further comprising a high band element disposed above a low band element forming a dual-band dual-polarized element.

12. An antenna assembly comprising:
a ground plane;
a directly fed probe having a vertical conductor and a plurality of horizontal conductors, wherein said directly fed probe is connected to the ground plane; and
a coupling patch radiator suspended above said directly fed probe and coupled with said directly fed probe.

13. The antenna assembly of claim 12, wherein said vertical conductors are substantially orthogonal to the ground plane and said horizontal conductors are substantially parallel to the ground plane.

14. The antenna assembly of claim 12, further comprising a board having a front surface and a rear surface, wherein said vertical conductor and plurality of horizontal conductors of each of said directly fed probe are on the front surface of said board, and further comprising an electromagnetically fed probe coupled with the coupling patch radiator, said electromagnetically fed probe having a vertical conductor and a plurality of horizontal conductors on the rear surface of said board, wherein said vertical conductor and plurality of horizontal conductors on the rear surface of said board are electromagnetically coupled with at least the vertical conductor on the front surface of said board.

15. The antenna assembly of claim 14, wherein said directly fed probe, electromagnetically fed probe and coupling patch form a radiator assembly, and further comprising a plurality of radiator assemblies.

16. The antenna assembly of claim 14, wherein said board has a left side and a right side, each of said left side and right side having a directly fed probe and an electromagnetically fed probe.

17. The antenna of claim 16, further comprising a radiator assembly formed by two of said boards intersecting one another to form a general x-shape, said coupling patch radiator suspended above said radiator assembly.
